(19) United States
(12) Patent Application Publication
(10) Pub. No.: US 2001/0040372 A1
(43) Pub. Date: Nov. 15, 2001

(54) METHOD FOR PROVIDING NUTRITIONAL INFORMATION ON FOOD PRODUCT PACKAGING

(75) Inventor: LOUIS C. ARGENTA, WINSTON-SALEM, NC (US)

Correspondence Address: CARL B MASSEY JR, KILPATRICK STOCKTON LLP, 1001 WEST FOURTH STREET, WINSTON-SALEM, NC, 27101

(73) Assignee: argenta

(21) Appl. No.: 09/389,133

(22) Filed: Sep. 2, 1999

Related U.S. Application Data
(60) Provisional application No. 60/099,038, filed on Sep. 3, 1998.

(51) Int. Cl. B32B 3/00; G09F 1/00; B42D 15/00

(52) U.S. Cl. 283/81; 283/56; 283/115

(57) ABSTRACT

The present invention relates to a method for labeling food products or packaging thereof, wherein a graphical representation such as a bar graph allows visual comparison and evaluation of levels of nutitionally important food product components. In addition of the relative length or height of columns of a bar graph, graded progression in color intensity or transitions from one color to another may be used to show various levels of a food product component. Standard columns may also be used to show acceptable levels by reference to an external standard. An axis to the graphical representation may also provide numerical data in relation to the levels of food product components.

### CROSS REFERENCE TO RELATED PATENT APPLICATION

This application claims the benefit of U.S. Provisional Patent Application No. 60/099,038, filed Sep. 3, 1998.

### FIELD OF THE INVENTION

The present invention provides methods for providing nutritional information on the packaging of food products to provide consumers with readily understandable means for ascertaining the relative levels of certain ingredients in the food product. The methods of the present invention will enhance the ability of individuals on restricted diets to readily ascertain whether a food product fits within their dietary guidelines.

### BACKGROUND

Currently available food products include ingredient labels which provide caloric information and information on the amounts of specific ingredients/constituents such as, fat, protein, carbohydrates, cholesterol, sodium, potassium and the like. The information is generally presented in numeric fashion, for example “Calories 240”, “Total Fat 2.5 g”, “Cholesterol 3 mg” etc. Although this numeric information is beneficial, it may be difficult for a consumer to interpret because it is provided without any frame of reference. For example, a consumer on a low cholesterol diet may be unable to interpret whether a food product including “Cholesterol 3 mg” is a low cholesterol product suitable for inclusion in their diet.

Accordingly, there exists a need for a method for labeling food products which may be more readily understood by consumers.

### SUMMARY OF THE INVENTION

The present invention provides methods for labeling food products which utilize visual markers to provide a consumer with a frame of reference with respect to the levels of ingredients included within the food product. The visual markers of the invention may comprise any pictographic represention including, but not limited to, bar graphs, pie charts, and diagrams. As will be understood from the following description, the present invention also provides food product packaging labeled according to the methods of the present invention.

For example, in one aspect, the present invention provides a method for labeling food products wherein the level of an ingredient or ingredients are represented graphically, for example utilizing a bar graph. In addition to the actual ingredient level, the bar graph may include additional information designed to provide a frame of reference for the consumer. For example, according to a method of the present invention a food product label may include a bar graph with a column for sodium level, and a column representing an acceptable sodium level for a product considered low in sodium. A consumer could quickly determine, by visually scanning the label and comparing the relative height of the columns, whether the food product was low in sodium.

In a preferred embodiment of the methods of the present invention nutritional information is provided graphically in the form of the colored bar graphs. The color or hue utilized for individual columns would provide a visual reference of the relative amount of the ingredient. Implementation of this embodiments may be accomplished in many different fashions.

In one embodiment, different ingredients could be labeled with different colors, with the relative amount of the ingredient, relative to an external standard such as recommended levels of nutrients for a fixed calorie (e.g. 2000 calorie) diet, being represented by the hue of the color. Acceptable external standards include the FDA dietary guidelines. By way of example, the amount of sodium in a food product could be represented by a generally red column. Low sodium products, relative to the FDA dietary guidelines, could include a relatively short column of a pink color. High sodium products could include a higher column transitioning in hue from pink near the bottom to bright red near the top.

Alternatively, different colors could be utilized to depict the relative levels of an ingredient. For example, green columns could be utilized to indicate a level of an ingredient which falls within an FDA dietary guideline, yellow columns could be utilized to indicate a level of an ingredient which falls near the cut-off level for a dietary guideline, and red columns could be utilized to indicate a level of an ingredient which falls outside the level of an FDA dietary guideline. These colors could be combined in a single column for reference purposes, or for indicating the level of an ingredient.

### BRIEF DESCRIPTION OF THE FIGURES

FIG. 1 shows an embodiment of the invention wherein height of columns of a bar graph represent levels of food product components. The columns are visually distinguished by color and an axis to the graph provides numerical values for component levels.

FIG. 2 shows an embodiment of the invention similar to that of FIG. 1, except that, in addition to the height of each column, the levels of each component are represented by a gradation in color intensity.

### DETAILED DESCRIPTION OF THE INVENTION

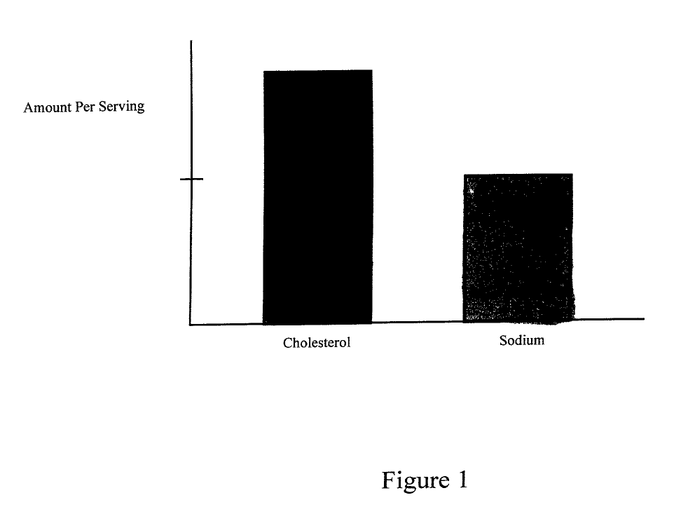

FIG. 1 depicts an embodiment of a food ingredient label which has been prepared in accordance with a method of the present invention. As shown in FIG. 1, a food label may comprise a bar graph having two columns representing the amount per serving of cholesterol and sodium in the product. As will be understood by those of ordinary skill in the art, additional ingredients may be included on the same or different bar graphs, in addition the axis of the graph may include numerals, e.g. milligrams, may be left blank or may be omitted altogether. In the label represented in FIG. 1 the amount of cholesterol per serving of the food product is above the FDA recommended dietary guidelines. Accordingly, the cholesterol column would be depicted in red.

The amount of sodium per serving of the food product falls within acceptable dietary guidelines, therefore the sodium column would be depicted in green.

A potential purchaser of the food product could do a visual scan of the label and readily determine that the product was relatively high in cholesterol and relatively low in sodium by comparing the colors of the columns and the relative heights of the columns.

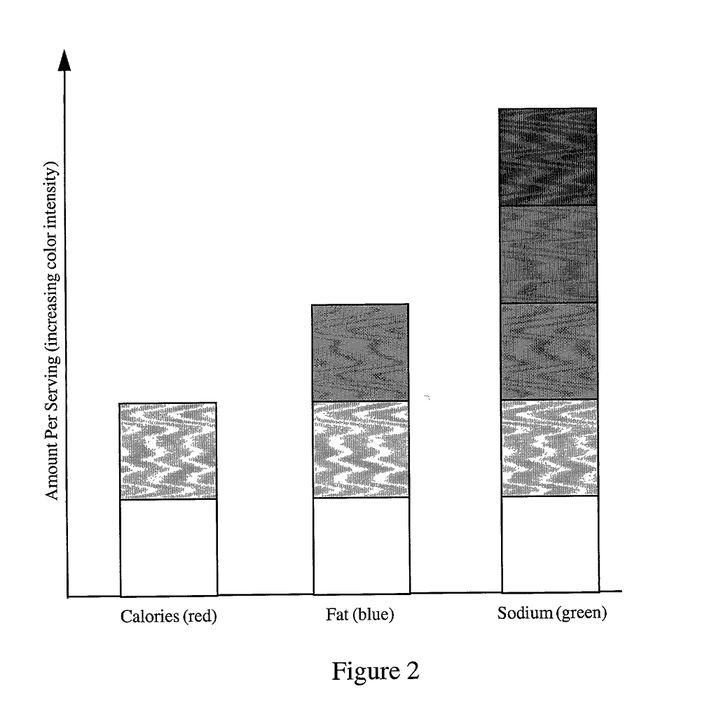

FIG. 2 provides another embodiment, and possibly a preferred embodiment, of a food label prepared according to the present invention. As shown in FIG. 2, the relative amount of an ingredient in a product is demonstrated by a progressively darkening hue of color. By way of example, levels of calories per serving, fat per serving and sodium (Na) per serving are usually of greatest interest to the consumers. The relative levels of calories per serving could be demonstrated by a relative intensity of the color red. The level of fat per serving could be demonstrated by a relative intensity of the color blue and the level of sodium per serving could be demonstrated by a relative intensity of the color green. If such a color scheme were universally adopted, consumers, including illiterate and/or uneducated consumers, could rapidly determine if a given food product would be safe or recommended for their diet by referring to the color intensity scheme.

Accordingly, in one aspect the invention relates to a method of labeling food products or packaging thereof, to show the level of at least one component of the food product comprising, affixing a label to the food product or packaging thereof, wherein the label comprises a graphical representation of the level of at least one component of the food product.

In a preferred embodiment, the graphical representation is a bar graph. More preferably, the bar graph comprises at least two columns wherein the length or height of at least one of the columns represents a nutritionally acceptably level of a component whose actual level in said food product is represented by the length or height of an adjacent column. Also more preferably, the nutritionally acceptable level is determined according to an external standard. Most preferably, the external standard is the United States Food and Drug Administration dietary guidelines.

In another preferred embodiment, the level of a component of the food product represented by the length or height of an individual column of the bar graph is further indicated by a progressive gradation in color intensity along the length or height of the column.

In another preferred embodiment, the columns of the bar graph representing individual components of the food product are individually colored to distinguish each column and the corresponding component represented from other columns and components represented on the same label.

In another preferred embodiment, different colors are used along the length or height of individual columns to further indicate relative levels of the food product components represented. More preferably, the colors green, yellow, and red are used to indicated acceptable, marginal, and unacceptable levels, respectively, of a food product component represented.

In another preferred embodiment, the food product components represented are selected from the group consisting of calories, cholesterol, fat, and sodium.

In another preferred embodiment, an axis to the graphical representation provides numerical information regarding levels of a food product component represented.

In another aspect, the invention relates to a food product label comprising a graphical representation of the level of at least one component of the food product.

In a preferred embodiment, the graphical representation is a bar graph. More preferably, the bar graph comprises at least two columns wherein the length or height of at least one of the columns represents a nutritionally acceptably level of a component whose actual level in the food product is represented by the length or height of an adjacent column. Also more preferably, the nutritionally acceptable level is determined according to an external standard. Most preferably, the external standard is the United States Food and Drug Administration dietary guidelines.

In another preferred embodiment, the level of a component of the food product represented by the length or height of an individual column of the bar graph is further indicated by a progressive gradation in color intensity along the length or height of the column.

In another preferred embodiment, the columns of the bar graph representing individual components of said food product are individually colored to distinguish each column and the corresponding component represented from other columns and components represented on the same label.

In another preferred embodiment, different colors are used along the length or height of individual columns of the bar graph to further indicate relative levels of the food product components represented. More preferably, the colors green, yellow, and red and used successively along the length or height of a column to indicate acceptable, marginal, or unacceptable levels, respectively, of a food product component represented.

In another preferred embodiment, the food product components represented are selected from the group consisting of calories, cholesterol, fat, and sodium.

In another preferred embodiment, an axis to the graphical representation provides numerical information regarding levels of a food product component represented.

The foregoing description of the present invention is provided by way of Example. As will be understood by those of ordinary skill in the art the food labeling concepts discussed herein as falling within the present invention may be implemented in a variety of different ways.

What is claimed:

1. A method of labeling food products or packaging thereof to show the level of at least one component of said food product comprising,
affixing a label to said food product or packaging thereof,
wherein said label comprises a graphical representation of the level of at least one component of said food product.

2. The method of claim 1, wherein said graphical representation is a bar graph.

3. The method of claim 2, wherein said bar graph comprises at least two columns, and wherein the length or height of at least one of said columns represents a nutritionally acceptably level of a component whose actual level in said food product is represented by the length or height of an adjacent column.

4. The method of claim 2, wherein the level of a component of said food product represented by the length or height of an individual column of said bar graph is further indicated by a progressive gradation in color intensity along the length or height of said column.

5. The method of claim 3, wherein said nutritionally acceptable level is determined according to an external standard.

6. The method of claim 4, wherein said external standard is the United States Food and Drug Administration dietary guidelines.

7. The method of claim 2, wherein columns of said bar graph representing individual components of said food product are individually colored to distinguish each column and the corresponding component represented from other columns and components represented on the same label.

8. The method of claim 2, wherein different colors are used along the length or height of individual columns to further indicate relative levels of the food product components represented.

9. The method of claim 3, wherein the colors green, yellow, and red are used to indicated acceptable, marginal, and unacceptable levels, respectively, of a food product component represented.

10. The method of claim 1, wherein the food product components represented are selected from the group consisting of calories, cholesterol, fat, and sodium.

11. The method of claim 1, wherein an axis to said graphical representation provides numerical information regarding levels of a food product component represented.

12. A food product label comprising a graphical representation of the level of at least one component of said food product.

13. The food product label of claim 12, wherein said graphical representation is a bar graph.

14. The food product label of claim 13, wherein said bar graph comprises at least two columns, and wherein the length or height of at least one of said columns represents a nutritionally acceptably level of a component whose actual level in said food product is represented by the length or height of an adjacent column.

15. The food product label of claim 13, wherein the level of a component of said food product represented by the length or height of an individual column of said bar graph is further indicated by a progressive gradation in color intensity along the length or height of said column.

16. The food product label of claim 13, wherein the columns of said bar graph representing individual components of said food product are individually colored to distinguish each column and the corresponding component represented from other columns and components represented on the same label.

17. The food product label of claim 13, wherein different colors are used along the length or height of individual columns of said bar graph to further indicate relative levels of the food product components represented.

18. The food product label of claim 17 wherein the colors green, yellow, and red and used successively along the length or height of a column to indicate acceptable, marginal, or unacceptable levels, respectively, of a food product component represented.

19. The food product label of claim 13, wherein the food product components represented are selected from the group consisting of calories, cholesterol, fat, and sodium.

20. The food product label of claim 13, wherein an axis to said graphical representation provides numerical information regarding levels of a food product component represented.
